(19) United States
(12) Patent Application Publication
(10) Pub. No.: US 2006/0011308 A1
(43) Pub. Date: Jan. 19, 2006

(54) Attaching apparatus for optical films

(75) Inventors: YunHui Huang, Shenzhen (CN); Tsung-Hsun Tsai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/182,229

(22) Filed: Jul. 15, 2005

(30) Foreign Application Priority Data
Jul. 16, 2004 (TW) 93121306

(51) Int. Cl. B29C 65/00; B23K 37/00; B32B 37/00

(52) U.S. Cl. 156/580; 156/556

(57) ABSTRACT

An attaching apparatus for attaching an optical film to a workpiece includes a workbench (11) for supporting the workpiece and the optical film; a roller device (40) for rolling the optical film into attachment with the workpiece. Either or both the roller device and the workbench are movable relative to the other. Aligning the optical film and turning the workpiece manually can be reduced. The attaching apparatus reduces manual labor and costs, and increases efficiency.

### BACKGROUND OF THE INVENTION

1. Field of the Invention

The present invention relates to an attaching apparatus for attaching optical films onto workpieces, and particularly to an attaching apparatus typically used to attach a reflective film to a light guide plate (LGP) of a liquid crystal display (LCD).

2. General Background

A backlight module of an LCD generally includes an LGP, a light source, a reflective film, and a prism plate. The light source is arranged opposite to a light incident surface of the LGP, the reflective film is arranged adjacent to a bottom surface of the LGP, and the prism plate is arranged adjacent to a light emitting surface of the LGP. The reflective film is attached to other side surfaces of the LGP, in order to prevent light from leaking.

A typical method of attaching a reflective film to an LGP is performed by aligning the reflective film and turning the LGP manually. This method may cause gaps to be formed between the reflective film and the LGP. Further, manual labor can be costly and inefficient.

What is needed, therefore, is an attaching apparatus for attaching a reflective film to an LGP, whereby the attachment can be effected accurately and efficiently.

### SUMMARY

In one preferred embodiment, an attaching apparatus for attaching an optical film to a workpiece includes a workbench for supporting the workpiece and the optical film; a roller device for rolling the optical film into attachment with the workpiece. Either or both the roller device and the workbench are movable relative to the other. Aligning the optical film and turning the workpiece manually can be reduced. The attaching apparatus reduces manual labor and costs, and increases efficiency.

Other advantages and novel features will become more apparent from the following detailed description of preferred embodiments when taken in conjunction with the accompanying drawings, in which:

### BRIEF DESCRIPTION OF THE DRAWINGS

FIG. 1 is an isometric view of an attaching apparatus used to attach a reflective film to an LGP, according to a preferred embodiment of the present invention;

FIG. 2 is an enlarged, exploded view of a support frame of the attaching apparatus of FIG. 1;

FIG. 3 is an enlarged, exploded view of a workbench unit of the attaching apparatus of FIG. 1;

FIG. 4 is an enlarged view of an elastic supporting device of the attaching apparatus of FIG. 1;

FIG. 5 is an enlarged, exploded view of a roller device of the attaching apparatus of FIG. 1;

FIG. 6 is an exploded view of a roller of the roller device of FIG. 5;

FIG. 7 is an enlarged, end view of the roller of the roller device of FIG. 5;

FIG. 8 is similar to FIG. 1, but showing a reflective film and an LGP engaged on the attaching apparatus prior to operation of the attaching apparatus to attach the reflective film onto sides of the LGP; and

FIG. 9 is similar to FIG. 8, but showing the reflective film attached onto the sides of the LGP after operation of the attaching apparatus.

### DETAILED DESCRIPTION OF PREFERRED EMBODIMENTS

Reference will now be made to the drawings to describe the preferred embodiments in detail.

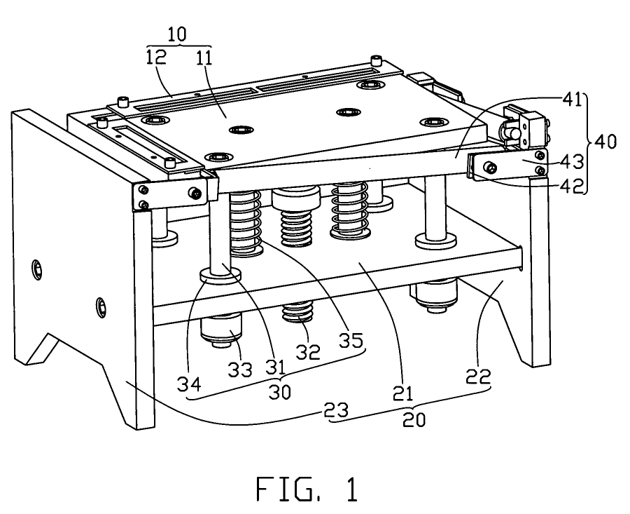

Referring to FIG. 1, an attaching apparatus for attaching a reflective film to an LGP in accordance with the preferred embodiment of the present invention includes a support frame 20, a workbench unit 10, an elastic supporting device 30, and two roller devices 40.

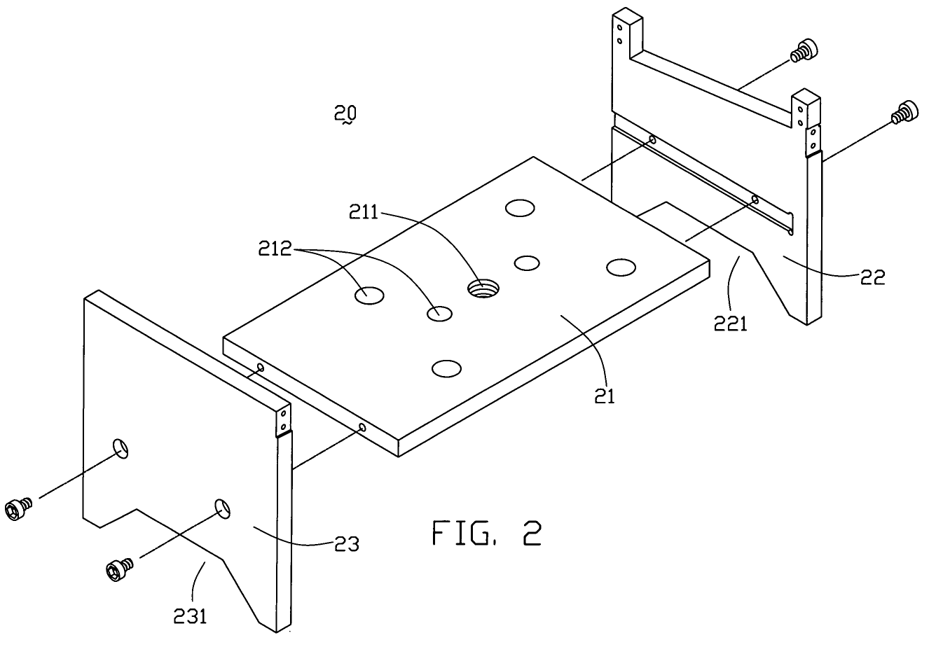

Referring to FIG. 2, the support frame 20 includes a table 21, and two side supports 22 and 23 supporting the table 21. The table 21 includes a screw hole 211 and a plurality of fixing holes 212. The screw hole 211 and the fixing holes 212 are all through holes. Each side support 22, 23 defines a cutout 221, 231, such that each side support 22, 23 has a pair of legs. The legs provide steady support for the attaching apparatus.

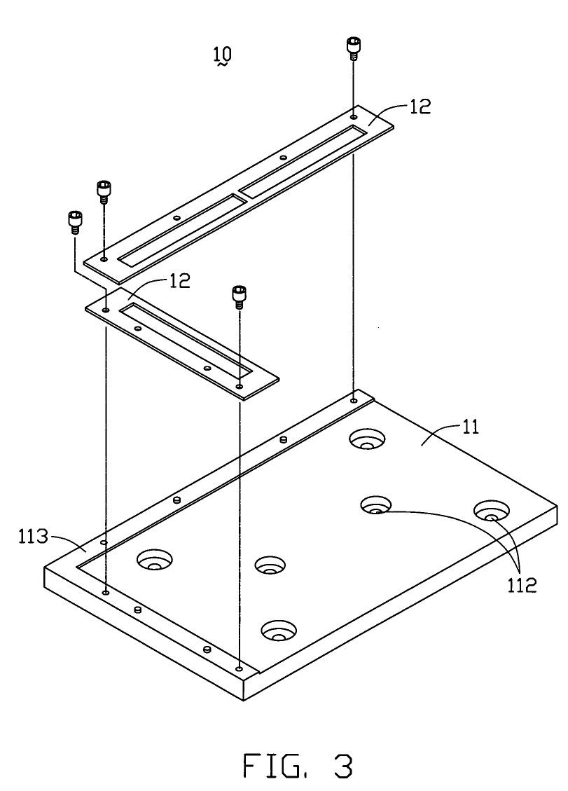

Referring to FIG. 3, the workbench unit 10 includes a workbench 11, two fixing plates 12, a plurality fixing holes 112, and a positioning strip 113. The workbench 11 further includes a raised, L-shaped positioning strip 113 formed on two adjacent edge portions of the workbench 11. The two fixing plates 12 are arranged on the positioning strip 113, and overhang the workbench 11. Therefore an L-shaped space is defined between the workbench 11 and the fixing plates 12. The fixing holes 112 of the workbench 11 are located corresponding to the fixing holes 212 of the table 21.

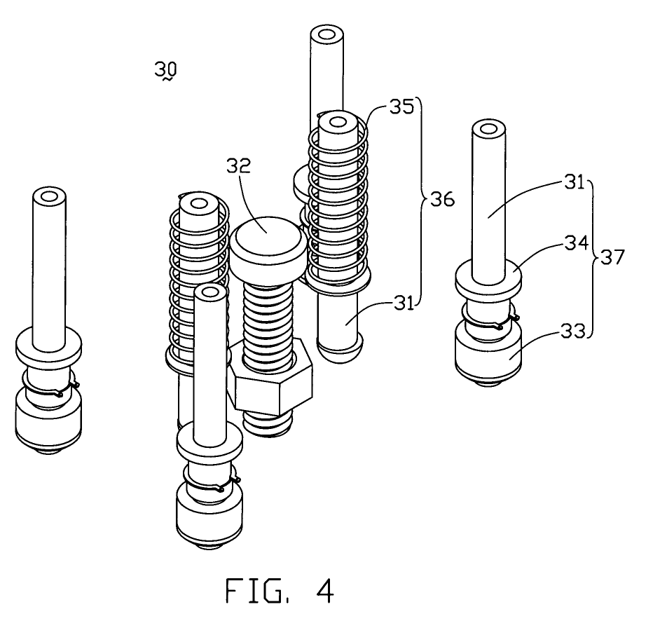

Referring to FIG. 4, the elastic supporting device 30 includes two elastic elements 36, a holding bolt 32, and a plurality of support elements 37. Each elastic element 36 includes a guide spindle 31, and a spring 35 positioned around the guide spindle 31. Each support element 37 includes a guide spindle 31′, an annular flange 34 formed around the guide spindle 31′, and a snap ring attached to a bottom end of the guide spindle 31′.

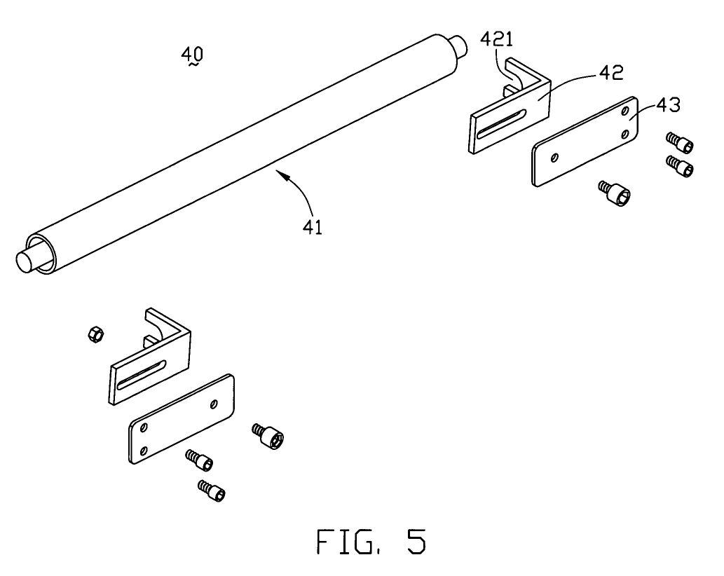

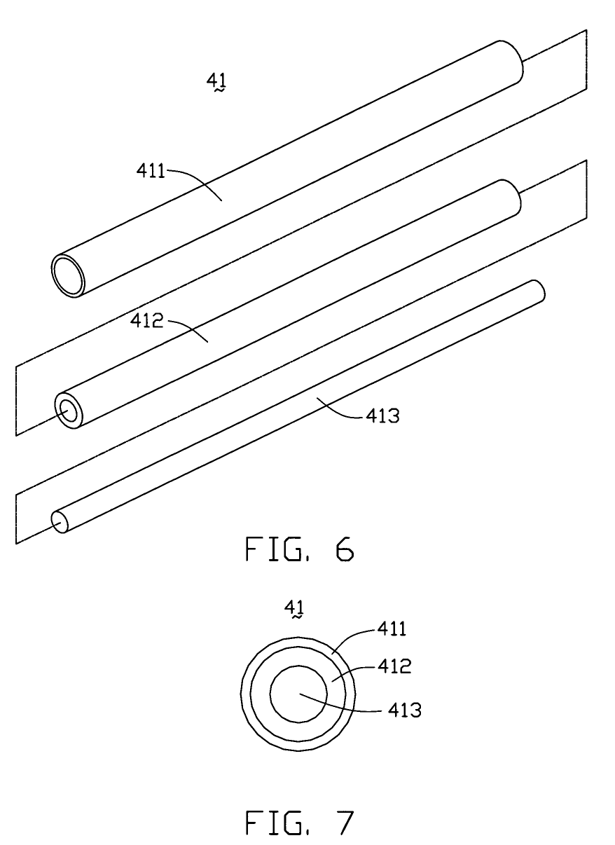

Referring to FIG. 5 through FIG. 7, each roller device 40 includes two flexible strips 43, two L-shaped brackets 42, and a roller 41. Each flexible strip 43 defines a plurality of screw holes (not labeled) for fixing the roller device 200 to the support frame 20. Each L-shaped bracket 42 has an indentation 421 in a distal end of a short side thereof, for receiving a corresponding end of the roller 41 therein. Each L-shaped bracket 42 also has a slot 422 along a long side thereof, for attachment of a corresponding flexible strip 43 to the L-shaped bracket 42 with the aid of a screw (not labeled) and a nut (not labeled). The roller 41 includes a revolving shaft 413, a revolving drum 412 located around the revolving shaft 413, and a rubber layer 411 covering the revolving drum 412. The revolving drum 412 can turn around the revolving shaft 413. Two ends (not labeled) of the revolving shaft 413 are respectively received in the indentations 421 of the L-shaped brackets 42, whereby the L-shaped brackets 42 support and hold the roller 41.

In assembly, the table 21 is fixed between the two side supports 22, 23 by screws (not labeled), thereby obtaining the support frame 20. The guide spindles 31 of the elastic elements 36 and the guide spindles 31′ of the support elements 37 are received through the corresponding fixing holes 212 of the table 21. The springs 35 are located around the guide spindles 31. The snap rings 33 are engaged around bottoms of the guide spindles 31′ of the support elements 37. Thus the flanges 34 and the snap rings 33 are disposed at top and bottom sides of the table 21 respectively, such that the support elements 37 are secured in the corresponding fixing holes 212 of the table 21. The holding bolt 32 is engaged in the screw hole 211 of the table 21, down to a predetermined distance away from the workbench 11. The workbench unit 10 is then engaged on the elastic supporting device 30, with the fixing holes 112 receiving top ends of the guide spindles 31, 31′. The workbench 11 is thus elastically supported on the springs 35 of the elastic elements 36, with the springs 35 held between the workbench 11 and the table 21. One of the roller devices 40 is fixed to top portions of front ends of the side supports 23, by screw attachment of the flexible strips 43 to the side supports 23. The other roller device 40 is fixed to top portions of opposite sides of one of the side supports 23, by screw attachment of the flexible strips 43 to that side support 23. The two roller devices 40 are thus disposed at two adjacent sides of the support frame 20, with each roller 41 inclined relative to the workbench 11. An elbow defined where the rollers 41 meet is diagonally opposite from an elbow of the positioning strip 113. Thus the support frame 20 supports and locates the workbench unit 10 by way of the elastic supporting device 30 and the roller devices 40.

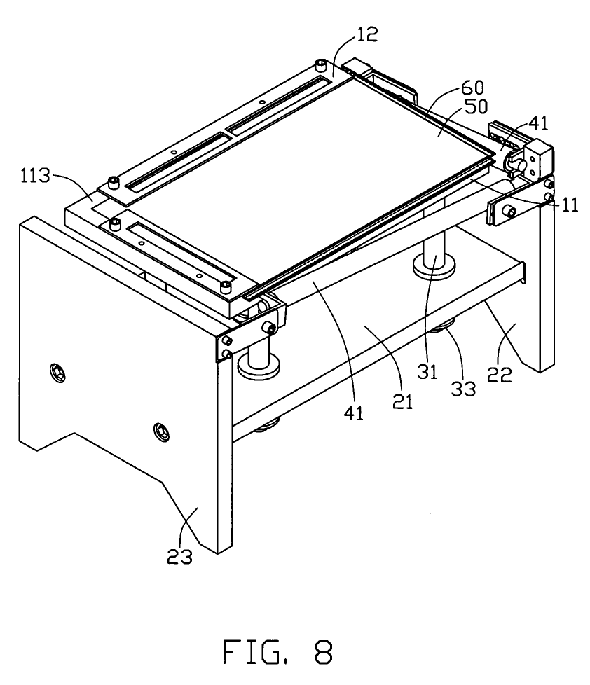

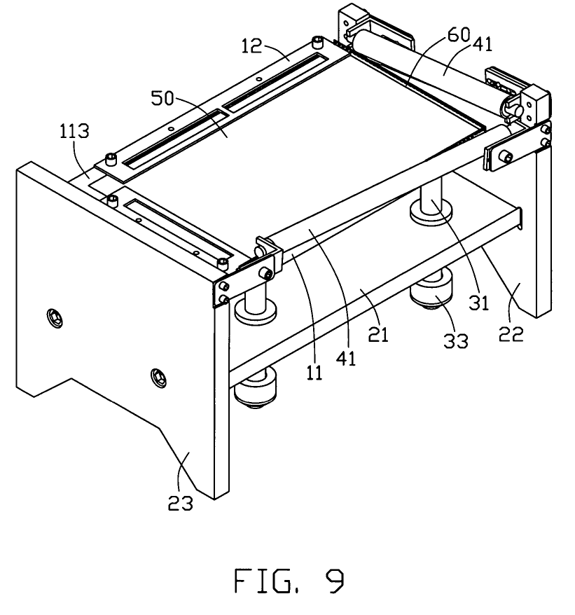

Referring to FIG. 8 and FIG. 9, a process of using the attaching apparatus to attach a reflective film to an LGP comprises the following steps. Firstly, an LGP 50 with a reflective film 60 is placed on the workbench 11. Two adjacent edges of the reflective film 60 are arranged in the space between the workbench 11 and the fixing plates 12. The LGP 50 is located such that two adjacent fixing plate sides thereof abut against the positioning strip 113 and are held by the fixing plates 12. Two adjacent edge portions (not labeled) of the reflective film 60 opposite the rollers 41 protrude out from the LGP 50 and the workbench 11. A common width of the edge portions corresponds to a thickness of the LGP 50. Secondly, the LGP 50 and the workbench unit 10 are pressed down until the workbench unit 10 touches the holding bolt 32. During this process, the rollers 41 turn and press roll the edge portions of the reflective film 60. Because the rollers 41 are inclined relative to the workbench 11, they maintain certain pressures on the two edge portions of the reflective film 60 as the LGP 50 descends, whereby the two edge portions of the reflective film 60 are attached to corresponding side surfaces of the LGP 50. Thirdly, the pressure on the LGP 50 is removed. The LGP 50 and the workbench 11 rise to their original positions because of decompression of the springs 35. Finally, the LGP 50 with the reflective film 60 attached thereon is taken off from the workbench 11.

With the fixing plates 12 and the positioning strip 113, the attaching apparatus of the preferred embodiment can precisely align the LGP 50 and the reflective film 60 before the reflective film 60 attaching process is performed. Furthermore, the LGP 50 and the reflective film 60 are protected from damage by the flexibility of the rubber layers 411. Moreover, the holding bolt 32 can adjustably limit the lowest position attainable by the workbench unit 10. The attaching apparatus reduces manual labor and costs, and increases efficiency.

In alternative embodiments, the snap rings 33 can replaced by, for example, the following fastening means. Bottom ends of the guide spindles 31′ can be threaded, and nuts can be engaged onto these bottom ends. The holding bolt 32 can instead be a holding pillar adjustably or non-adjustably arranged on the table 21. The L-shaped brackets 42 can be omitted. This can be done by changing the shape of each flexible strip 43, so that an end of the modified flexible strip 43 directly connects with a corresponding end of the corresponding revolving shaft 413. The rubber layer 411 of each roller device 40 can be omitted, particularly if the revolving drum 412 of the roller device 40 is made from a suitable elastic material. The positioning strip 113 can be omitted, with the fixing plates 12 being modified to include portions that cooperatively function as a protrude unit. The number of guide spindles 31, flanges 34, springs 35 and snap rings 33 of the elastic supporting device 30 can be determined according to need. Only a single roller 40 may be employed, if only one side surface of the LGP 50 needs to have a portion of the reflective film 60 attached thereto.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. An attaching apparatus for attaching an optical film to a workpiece, comprising:
a workbench for supporting the workpiece and the optical film;
a roller device for rolling the optical film into attachment with the workpiece, wherein either or both the roller device and the workbench are movable relative to the other.

2. The attaching apparatus as claimed in claim 1, further comprising a support frame supporting the workbench and the roller device.

3. The attaching apparatus as claimed in claim 2, wherein the support frame comprises a table, and two side supports supporting the table.

4. The attaching apparatus as claimed in claim 3, wherein each side support comprises a pair of legs, for providing steady support for the attaching apparatus.

5. The attaching apparatus as claimed in claim 1, further comprising an elastic supporting device for elastically supporting the workbench.

6. The attaching apparatus as claimed in claim 5, wherein the elastic supporting device is arranged generally between the table and the workbench.

7. The attaching apparatus as claimed in claim 6, wherein the elastic supporting device comprises a holding bolt adjustably engaged with and protruding above the table.

8. The attaching apparatus as claimed in claim 5, wherein the elastic supporting device comprises a plurality supporting elements for stably supporting the workbench thereon.

9. The attaching apparatus as claimed in claim 5, wherein the elastic supporting device comprises an elastic element.

10. The attaching apparatus as claimed in claim 9, wherein the elastic element comprises a guide spindle, and a spring located around the guide spindle.

11. The attaching apparatus as claimed in claim 1, wherein the workbench comprises a positioning portion at two adjacent sides thereof.

12. The attaching apparatus as claimed in claim 11, further comprising a fixing member arranged on the positioning portion.

13. The attaching apparatus as claimed in claim 1, wherein the roller device comprises a roller arranged at a side of the workbench.

14. The attaching apparatus as claimed in claim 13, wherein the roller is inclined relative to the workbench.

15. The attaching apparatus as claimed in claim 13, wherein the roller comprises a revolving shaft, and a revolving drum around the revolving shaft.

16. The attaching apparatus as claimed in claim 1, wherein the roller device comprises at least one fixing member for holding the roller device in position.

17. The attaching apparatus as claimed in claim 16, wherein the at least one fixing member is two fixing members, and each fixing member comprises a flexible strip and an L-shaped bracket.

18. An attaching apparatus for attaching an optical film to a workpiece, comprising:
a workbench for supporting the workpiece and the optical film;
a roller device for rolling the optical film into attachment with the workpiece, wherein
a rotation axis of said roller is oblique to an edge of said workpiece adjacent thereto for rolling the optical film into attachment with the workpiece.

19. An attaching apparatus for attaching an optical film to a workpiece, comprising:
a workbench for supporting the workpiece and the optical film, said workpiece defining four side edges; and
first and second rollers closely located beside two adjacent side edges of said four sides for rolling the optical film into attachment with the workpiece.

20. The attaching apparatus as claimed in claim 19, wherein the workpiece and the rollers are vertically moved relative to each other.
